(19) United States
(12) Patent Application Publication
(10) Pub. No.: US 2024/0409716 A1
(43) Pub. Date: Dec. 12, 2024

(54) SILANE-AZODICARBONAMIDE MIXTURES, PROCESS FOR PRODUCTION THEREOF AND USE THEREOF

(71) Applicant: Evonik Operations GmbH, Essen (DE)

(72) Inventors: Andre WEHMEIER, Bornheim (DE); Hannes JÜRGENS, Hamburg (DE); Alexander KÖPFER, Bernau im Schwarzwald (DE); Katharina Marie PAULUS, Freiburg (DE); Jens KIESEWETTER, Bornheim (DE); Roland KRAFCZYK, Rheinfelden (DE); Benjamin VIEL, Hanau (DE); Elisabeth BAUER, Kleines Wiesental (DE); Lara METZGER, Schopfheim (DE); Julian ASAL, Rheinfelden (DE)

(73) Assignee: Evonik Operations GmbH, Essen (DE)

(21) Appl. No.: 18/699,989

(22) PCT Filed: Oct. 7, 2022
(86) PCT No.: PCT/EP2022/077957

§ 371 Date: Apr. 10, 2024

(30) Foreign Application Priority Data
Oct. 21, 2021 (EP) 21203839.2

(51) Int. Cl. C08K 5/548; C08K 5/23; C08K 5/5455

(52) U.S. Cl. CPC C08K 5/548; C08K 5/23; C08K 5/5455; C08K 2201/014

(57) ABSTRACT

The invention relates to silane-azodicarbonamide mixtures containing 5-95% by weight of azocarbonyl-functionalized silane of formula I based on the total amount of azocarbonyl-functionalized silane of formula I, silane of formula II and azodicarbonamide of formula III, (R¹)₃₋ₐ(R²)ₐSi—R³—NH—C(O)—N═N—R⁴ (I), 0-90% by weight of silane of formula II based on the total amount of azocarbonyl-functionalized silane of formula I, silane of formula II and azodicarbonamide compound of formula III, (R¹)_{y}(R²)_{3-y} Si—R³—Sₓ—R³—Si(R¹)_{y}(R²)_{3-y} (II) and 1-80% by weight of azodicarbonamide compound of formula III based on the total amount of azocarbonyl-functionalized silane of formula I, silane of formula II and azodicarbonamide compound of formula III, R⁵—NH—C(O)—N═N—C(O)—NH—R⁵ (III). The silane-azodicarbonamide mixture is produced by mixing 5-95% by weight of azocarbonyl-functionalized silane of formula I, 0-90% by weight of silane of formula II and 1-80% by weight of azodicarbonamide compound of formula III. The invention further relates to a rubber mixture containing at least one rubber, 5-95% by weight of azocarbonyl-functionalized silane of formula I, 0-90% by weight, silane of formula II and 1-80% by weight of azodicarbonamide compound of formula III.

The invention relates to silicone-azodicarbonamide mixtures, to processes for the production thereof and to the use thereof in rubber mixtures.

EP 2937351 discloses azocarbonyl-functionalized silanes of formula (R¹)₃₋ₐ(R²)ₐSi—R¹—NH—C(O)—N═N—R⁴.

Also disclosed in KR20170049245 are alkyl-substituted azodicarbonamide compounds of formula R⁵—NH—C(O)—N═N—C(O)—NH—R⁵, wherein R⁵ is a linear or branched cyclic alkyl radical.

A disadvantage of the known silanes in the rubber mixtures is the low 300% modulus.

It is an object of the present invention to provide rubber mixtures containing silane-azodicarbonamide mixtures which show improvements in the 300% modulus relative to the known rubber mixtures.

The present invention provides a silane-azodicarbonamide mixture containing 5-95% by weight, preferably 5-50% by weight, particularly preferably 20-40% by weight, of azocarbonyl-functionalized silane of formula I based on the total amount of azocarbonyl-functionalized silane of formula I, silane of formula II and azodicarbonamide compound of formula III,

(R¹)₃₋ₐ(R²)ₐSi—R³—NH—C(O)—N═N—R⁴ (I),

0-90% by weight, preferably 20-60% by weight, particularly preferably 30-60% by weight, of silane of formula II based on the total amount of azocarbonyl-functionalized silane of formula I, silane of formula II and azodicarbonamide compound of formula III,

(R¹)_{y}(R²)_{3-y}Si—R³—Sₓ—R³—Si(R¹)_{y}(R²)_{3-y} (II) and

1-80% by weight, preferably 5-50% by weight, particularly preferably 15-40% by weight, of azodicarbonamide compound of formula III based on the total amount of azocarbonyl-functionalized silane of formula I, silane of formula II and azodicarbonamide compound of formula III,

R⁵—NH—C(O)—N═N—C(O)—NH—R⁵ (III),

wherein R¹ are identical or different and represent C1-C10-alkoxy groups, preferably methoxy or ethoxy groups, phenoxy group or alkylpolyether group —O—(R⁶—O)ᵣ—R⁷ where R⁶ are identical or different and represent a branched, saturated or unsaturated, aliphatic, aromatic or mixed aliphatic/aromatic divalent C1-C30 hydrocarbon group, preferably —CH₂—CH₂—, r is an integer from 1 to 30, preferably 3 to 10, and R⁷ represents unsubstituted or substituted, branched or unbranched monovalent alkyl, alkenyl, aryl or aralkyl groups, preferably represents C₁₃H₂₇ alkyl group, R² are identical or different and represent —OH, C6-C20-aryl groups, preferably phenyl, C1-C10-alkyl groups, preferably methyl or ethyl, C2-C20-alkenyl group, C7-C20-aralkyl group or halogen, preferably Cl,
a is 0 to 3, preferably 0,
y is 0 to 3, preferably 3,
R³ are identical or different and represent a branched or unbranched, saturated or unsaturated, aliphatic, aromatic or mixed aliphatic/aromatic divalent C1-C30-hydrocarbon group, preferably C1-C20, particularly preferably C1-C10, very particularly preferably C2-C7-, especially preferably CH₂CH₂ and CH₂CH₂CH₂,
R⁴ represents a substituted or unsubstituted aryl or substituted or unsubstituted alkyl group, preferably phenyl, halophenyl, for example chlorophenyl, bromophenyl or iodophenyl, tolyl, alkoxyphenyl, for example methoxyphenyl, o-, m- or p-nitrophenyl, or substituted or unsubstituted alkyl, preferably methyl, ethyl, propyl, butyl, isobutyl, tert-butyl, nitromethyl, nitroethyl, nitropropyl, nitrobutyl or nitroisobutyl,
x is the average sulfur chain distribution, wherein x is 2 to 10, preferably 2 to 4,
R⁵ are identical or different and represent a branched or unbranched, saturated or unsaturated, aliphatic or cyclic monovalent C1-C30-hydrocarbon group, preferably C1-C20-, particularly preferably C1-C10-, very particularly preferably C2-C8-, especially preferably CH(CH₃)₂, CH₂CH(CH₃)₂, C(CH₃)₃, CH₂C(CH₃)₃, CH₂CH₂CH(CH₃)₂, CH₂CH(CH₃) CH₂CH₃, CH₂CH(CH₂CH₃)₂, CH₂CH₂CH(CH₂CH₂CH₃)CH₂CH₂CH₂CH₃, CH₂CH(CH₂CH₃)CH₂CH₂CH₂CH₃, or a substituted or unsubstituted aryl group, preferably phenyl.

R³ independently of one another represent —CH₂—, —CH₂CH₂—, —CH₂CH₂CH₂—, —C H₂CH₂CH₂CH₂—, —CH(CH₃)—, —CH₂CH(CH₃)—, —CH(CH₃)CH₂—, —C(CH₃)₂—, —CH(C₂H₅)—, —CH₂CH₂CH(CH₃)—, —CH(CH₃)CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH₂CH₂CH₂CH₂CH₂—, —CH₂CH₂CH₂CH₂CH₂CH₂CH₂CH₂—, —CH₂CH₂CH₂CH₂CH₂CH₂CH₂CH₂CH₂—, —CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂CH₂CH₂—, —CH₂CH₂CH₂CH₂CH₂CH₂CH₂CH₂CH₂CH₂CH₂CH₂CH₂CH₂CH₂CH₂CH₂CH₂- or

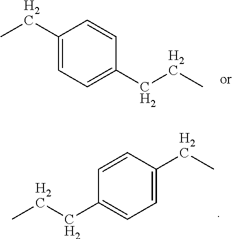

The azocarbonyl-functionalized silane of formula I may preferably be (CH₃CH₂O—)₃Si-CH₂—NH—CO—N═N-phenyl,
(CH₃CH₂O—)₃Si—(CH₂)₂—NH—CO—N═N-phenyl,
(CH₃CH₂O—)₃Si—(CH₂)₃—NH—CO—N═N-phenyl,
(CH₃O—)₃Si—CH₂—NH—CO—N═N-phenyl,
(CH₃O—)₃Si—(CH₂)₂—NH—CO—N═N-phenyl,
(CH₃O—)₃Si—(CH₂)₃—NH—CO—N═N-phenyl,
(CH₃CH₂O—)₂Si(—O(CH₂—CH₂—O)₅—C13H₂₇)—CH₂—NH—CO—N═N-phenyl,
(CH₃CH₂O—)₂Si(—O(CH₂—CH₂—O)₅—C13H₂₇)—(CH₂)₂—NH—CO—N═N-phenyl,
(CH₃CH₂O—)₂Si(—O(CH₂—CH₂—O)₅—C13H₂₇)—(CH₂)₃—NH—CO—N═N-phenyl,
(CH₃CH₂O—)Si(—O(CH₂—CH₂—O)₅—C13H₂₇)₂—CH₂—NH—CO—N═N-phenyl,
(CH₃CH₂O—)Si(—O(CH₂—CH₂—O)₅—C13H₂₇)₂—(CH₂)₂—NH—CO—N═N-phenyl,
(CH₃CH₂O—)Si(—O(CH₂—CH₂—O)₅—C13H₂₇)₂—(CH₂)₃—NH—CO—N═N-phenyl,
(CH₃CH₂O—)₃Si—(CH₂)₂—NH—CO—N═N-(p-nitrophenyl),
(CH₃CH₂O—)₃Si—(CH₂)₃—NH—CO—N═N-(p-nitrophenyl),
(CH₃O—)₃Si—CH₂—NH—CO—N═N-(p-nitrophenyl),
(CH₃O—)₃Si—(CH₂)₂—NH—CO—N═N-(p-nitrophenyl),
(CH₃O—)₃Si—(CH₂)₃—NH—CO—N═N-(p-nitrophenyl),
(CH₃CH₂O—)₂Si(—O(CH₂—CH₂—O)₅—C13H₂₇)—CH₂—NH—CO—N═N-(p-nitrophenyl),
(CH₃CH₂O—)₂Si(—O(CH₂—CH₂—O)₅—C13H₂₇)—(CH₂)₂—NH—CO—N═N-(p-nitrophenyl),
(CH₃CH₂O—)₂Si(—O(CH₂—CH₂—O)₅—C13H₂₇)—(CH₂)₃—NH—CO—N═N-(p-nitrophenyl),
(CH₃CH₂O—)Si(—O(CH₂—CH₂—O)₅—C13H₂₇)₂—CH₂—NH—CO—N═N-(p-nitrophenyl),
(CH₃CH₂O—)Si(—O(CH₂—CH₂—O)₅—C13H₂₇)₂—(CH₂)₂—NH—CO—N═N-(p-nitrophenyl),
(CH₃CH₂O—)Si(—O(CH₂—CH₂—O)₅—C13H₂₇)₂—(CH₂)₃—NH—CO—N═N-(p-nitrophenyl),
(CH₃CH₂O—)₃Si—CH₂—NH—CO—N═N—CH₃,
(CH₃CH₂O—)₃Si—(CH₂)₂—NH—CO—N═N—CH₃,
(CH₃CH₂O—)₃Si—(CH₂)₃—NH—CO—N═N—CH₃,
(CH₃O—)₃Si—CH₂—NH—CO—N═N—CH₃,
(CH₃O—)₃Si—(CH₂)₂—NH—CO—N═N—CH₃,
(CH₃O—)₃Si—(CH₂)₃—NH—CO—N═N—CH₃,
(CH₃CH₂O—)₃Si—CH₂—NH—CO—N═N—CH₂CH₃,
(CH₃CH₂O—)₃Si—(CH₂)₂—NH—CO—N═N—CH₂CH₃,
(CH₃CH₂O—)₃Si—(CH₂)₃—NH—CO—N═N—CH₂CH₃,
(CH₃O—)₃Si—CH₂—NH—CO—N═N—CH₂CH₃,
(CH₃O—)₃Si—(CH₂)₂—NH—CO—N═N—CH₂CH₃,
(CH₃O—)₃Si—(CH₂)₃—NH—CO—N═N—CH₂CH₃,
(CH₃CH₂O—)₃Si—CH₂—NH—CO—N═N—CH₂CH₂CH₃,
(CH₃CH₂O—)₃Si—(CH₂)₂—NH—CO—N═N—CH₂CH₂CH₃,
(CH₃CH₂O—)₃Si—(CH₂)₃—NH—CO—N═N—CH₂CH₂CH₃,
(CH₃O—)₃Si—CH₂—NH—CO—N═N—CH₂CH₂CH₃,
(CH₃O—)₃Si—(CH₂)₂—NH—CO—N═N—CH₂CH₂CH₃,
(CH₃O—)₃Si—(CH₂)₃—NH—CO—N═N—CH₂CH₂CH₃,
(CH₃CH₂O—)₃Si—CH₂—NH—CO—N═N—CH₂CH₂CH₂CH₃,
(CH₃CH₂O—)₃Si—(CH₂)₂—NH—CO—N═N—CH₂CH₂CH₂CH₃,
(CH₃CH₂O—)₃Si—(CH₂)₃—NH—CO—N═N—CH₂CH₂CH₂CH₃,
(CH₃O—)₃Si—CH₂—NH—CO—N═N—CH₂CH₂CH₂CH₃,
(CH₃O—)₃Si—(CH₂)₂—NH—CO—N═N—CH₂CH₂CH₂CH₃,
(CH₃O—)₃Si—(CH₂)₃—NH—CO—N═N—CH₂CH₂CH₂CH₃,
(CH₃CH₂O—)₃Si—CH₂—NH—CO—N═N—C(CH₃)₃,
(CH₃CH₂O—)₃Si—(CH₂)₂—NH—CO—N═N—C(CH₃)₃,
(CH₃CH₂O—)₃Si—(CH₂)₃—NH—CO—N═N—C(CH₃)₃,
(CH₃O—)₃Si—CH₂—NH—CO—N═N—C(CH₃)₃,
(CH₃O—)₃Si—(CH₂)₂—NH—CO—N═N—C(CH₃)₃ or
(CH₃O—)₃Si—(CH₂)₃—NH—CO—N═N—C(CH₃)₃,
and particularly preferably
(CH₃CH₂O—)₃Si—(CH₂)₃—NH—CO—N═N-phenyl,
(CH₃O—)₃Si—(CH₂)₃—NH—CO—N═N-phenyl,
(CH₃CH₂O—)₃Si—(CH₂)₃—NH—CO—N═N-(p-nitrophenyl).

The silane of formula II may preferably be
[(MeO)₃Si(CH₂)₃]₂S, [(MeO)₃Si(CH₂)₃]₂S₂, [(MeO)₃Si(CH₂)₃]₂S₃, [(MeO)₃Si(CH₂)₃]₂S₄,
[(MeO)₃Si(CH₂)₃]₂S₅, [(MeO)₃Si(CH₂)₃]₂S₆, [(MeO)₃Si(CH₂)₃]₂S₇, [(MeO)₃Si(CH₂)₃]₂S₈,
[(MeO)₃Si(CH₂)₃]₂S₉, [(MeO)₃Si(CH₂)₃]₂S₁₀, [(MeO)₃Si(CH₂)₃]₂S₁₁, [(MeO)₃Si(CH₂)₃]₂S₁₂,
[(EtO)₃Si(CH₂)₃]₂S, [(EtO)₃Si(CH₂)₃]₂S₂, [(EtO)₃Si(CH₂)₃]₂S₃, [(EtO)₃Si(CH₂)₃]₂S₄,
[(EtO)₃Si(CH₂)₃]₂S₅, [(EtO)₃Si(CH₂)₃]₂S₆, [(EtO)₃Si(CH₂)₃]₂S₇, [(EtO)₃Si(CH₂)₃]₂S₈,
[(EtO)₃Si(CH₂)₃]₂S₉, [(EtO)₃Si(CH₂)₃]₂S₁₀, [(EtO)₃Si(CH₂)₃]₂S₁₁, [(EtO)₃Si(CH₂)₃]₂S₁₂,
[(C₃H₇O)₃Si(CH₂)₃]₂S, [(C₃H₇O)₃Si(CH₂)₃]₂S₂, [(C₃H₇O)₃Si(CH₂)₃]₂S₃, [(C₃H₇O)₃Si(CH₂)₃]₂S₄,
[(C₃H₇O)₃Si(CH₂)₃]₂S₅, [(C₃H₇O)₃Si(CH₂)₃]₂S₆, [(C₃H₇O)₃Si(CH₂)₃]₂S₇, [(C₃H₇O)₃Si(CH₂)₃]₂S₈,
[(C₃H₇O)₃Si(CH₂)₃]₂S₉, [(C₃H₇O)₃Si(CH₂)₃]₂S₁₀, [(C₃H₇O)₃Si(CH₂)₃]₂S₁₁, [(C₃H₇O)₃Si(CH₂)₃]₂S₁₂,
[(EtO)₂(C₁₃H₂₇—(OCH₂CH₂)₅₀)Si(CH₂)₃]₂S, [(EtO)₂(C₁₃H₂₇—(OCH₂CH₂)₅₀)Si(CH₂)₃]₂S₂,
[(EtO)₂(C₁₃H₂₇—(OCH₂CH₂)₅₀)Si(CH₂)₃]₂S₃, [(EtO)₂(C₁₃H₂₇—(OCH₂CH₂)₅₀)Si(CH₂)₃]₂S₄,
[(EtO)₂(C₁₃H₂₇—(OCH₂CH₂)₅₀)Si(CH₂)₃]₂S₅, [(EtO)₂(C₁₃H₂₇—(OCH₂CH₂)₅₀)Si(CH₂)₃]₂S₆,
[(EtO)₂(C₁₃H₂₇—(OCH₂CH₂)₅₀)Si(CH₂)₃]₂S₇, [(EtO)₂(C₁₃H₂₇—(OCH₂CH₂)₅₀)Si(CH₂)₃]₂S₈,
[(EtO)₂(C₁₃H₂₇—(OCH₂CH₂)₅O)Si(CH₂)₃]₂S₉[(EtO)₂(C₁₃H₂₇—(OCH₂CH₂)₅O)Si(CH₂)₃]₂S₁₀,
[(EtO)₂(C₁₃H₂₇—(OCH₂CH₂)₅O)Si(CH₂)₃]₂S₁₁[(EtO)₂(C₁₃H₂₇—(OCH₂CH₂)₅O)Si(CH₂)₃]₂S₁₂,
[(EtO)(C₁₃H₂₇—(OCH₂CH₂)₅₀)₂Si(CH₂)₃]₂S, [(EtO)(C₁₃H₂₇—(OCH₂CH₂)₅₀)₂Si(CH₂)₃]₂S₂,
[(EtO)(C₁₃H₂₇—(OCH₂CH₂)₅₀)₂Si(CH₂)₃]₂S₃, [(EtO)(C₁₃H₂₇—(OCH₂CH₂)₅₀)₂Si(CH₂)₃]₂S₄,
[(EtO)(C₁₃H₂₇—(OCH₂CH₂)₅₀)₂Si(CH₂)₃]₂S₅, [(EtO)(C₁₃H₂₇—(OCH₂CH₂)₅₀)₂Si(CH₂)₃]₂S₆,
[(EtO)(C₁₃H₂₇—(OCH₂CH₂)₅₀)₂Si(CH₂)₃]₂S₇, [(EtO)(C₁₃H₂₇—(OCH₂CH₂)₅₀)₂Si(CH₂)₃]₂S₈,
[(EtO)(C₁₃H₂₇—(OCH₂CH₂)₅₀)₂Si(CH₂)₃]₂S₉, [(EtO)(C₁₃H₂₇—(OCH₂CH₂)₅₀)₂Si(CH₂)₃]₂S₁₀,
[(EtO)(C₁₃H₂₇—(OCH₂CH₂)₅₀)₂Si(CH₂)₃]₂S₁₁, [(EtO)(C₁₃H₂₇—(OCH₂CH₂)₅₀)₂Si(CH₂)₃]₂S₁₂,
and may particularly preferably be [(EtO)₃Si(CH₂)₃]₂S, [(EtO)₃Si(CH₂)₃]₂S₂, [(EtO)₃Si(CH₂)₃]₂S₃, [(EtO)₃Si(CH₂)₃]₂S₄, [(EtO)₃Si(CH₂)₃]₂S₅, [(EtO)₃Si(CH₂)₃]₂S₆, [(EtO)₃Si(CH₂)₃]₂S₇,
[(EtO)₃Si(CH₂)₃]₂S₈, [(EtO)₃Si(CH₂)₃]₂S₉, [(EtO)₃Si(CH₂)₃]₂S₁₀, [(EtO)₃Si(CH₂)₃]₂S₁₁,
[(EtO)₃Si(CH₂)₃]₂S₁₂.

The azodicarbonamide compound of formula III may preferably be
CH₃—(CH₂)₃—NH—C(═O)—N═N—C(═O)—NH—(CH₂)₃—CH₃
CH₃—(CH₂)₄—NH—C(═O)—N═N—C(═O)—NH—(CH₂)₄—CH₃
CH₃—(CH₂)₅—NH—C(═O)—N═N—C(═O)—NH—(CH₂)₅—CH₃
CH₃—(CH₂)₆—NH—C(═O)—N═N—C(═O)—NH—(CH₂)₆—CH₃
CH₃—(CH₂)₇—NH—C(═O)—N═N—C(═O)—NH—(CH₂)₇—CH₃
CH₃—(CH₂)₈—NH—C(═O)—N═N—C(═O)—NH—(CH₂)₈—CH₃
CH₃—(CH₂)₉—NH—C(═O)—N═N—C(═O)—NH—(CH₂)₉—CH₃
CH₃—(CH₂)₁₀—NH—C(═O)—N═N—C(═O)—NH—(CH₂)₁₀—CH₃
CH₃—(CH₂)₁₁—NH—C(═O)—N═N—C(═O)—NH—(CH₂)₁₁—CH₃
(H₃C)₂CH—NH—C(═O)—N═N—C(═O)—NH—CH(CH₃)₂
(H₃C)₂CH—CH₂—NH—C(═O)—N═N—C(═O)—NH—CH₂—CH(CH₃)₂
(H₃C)₃C—NH—C(═O)—N═N—C(═O)—NH—C(CH₃)₃
(H₃C)₃C—CH₂—NH—C(═O)—N═N—C(═O)—NH—CH₂—C(CH₃)₃
(H₃C)₂CH—(CH₂)₂—NH—C(═O)—N═N—C(═O)—NH—(CH₂)₂—CH(CH₃)₂
H₃C—CH₂—(H₃C)CH—CH₂, —NH—C(═O)—N═N—C(═O)—NH—CH₂—CH(CH₃)—CH₂—CH₃,
(H₃C—H₂C)₂CH—CH₂—NH—C(═O)—N═N—C(═O)—NH—CH₂—CH(CH₂CH₃)₂
H₃C—(CH₂)₃—(H₅C2)CH—CH₂—NH—C(═O)—N═N—C(═O)—NH—CH₂—CH(C₂H)—(CH₂)₃—CH₃
H₃C—(CH₂)₃—(H₇C3)CH—CH₂—CH₂—NH—C(═O)—N═N—C(═O)—NH—CH₂—CH₂—CH(C₃H₇)—(CH₂)₃—CH₃
H₅C6-NH—C(═O)—N═N—C(═O)—NH—C6H₅
and particularly preferably be
CH₃(CH₂)₆—NH—C(═O)—N═N—C(═O)—NH—(CH₂)₅—CH₃
CH₃(CH₂)₇—NH—C(═O)—N═N—C(═O)—NH—(CH₂)₇—CH₃
CH₃(CH₂)₃—CH(C₂H₅)—CH₂—NH—C(═O)—N═N—C(═O)—NH—CH₂—CH(C₂H₅)—(CH₂)₃—CH₃ CH₃—(CH₂)₃—CH(C₃H₇)—CH₂—CH₂—NH—C(═O)—N═N—C(═O)—NH—CH₂—CH₂—CH(C₃H₇)—(CH₂)₃—CH₃.

The silane-azodicarbonamide mixture may preferably contain an azocarbonyl-functionalized silane of formula I

(R¹)₃₋ₐ(R²)ₐSi—R³—NH—C(O)—N═N—R⁴ (I),

a silane of formula II

(R¹)_{y}(R²)_{3-y}Si—R³—Sₓ—R³—Si(R¹)_{y}(R²)_{3-y} (II) and

an azodicarbonamide compound of formula III

R⁵—NH—C(O)—N═N—C(O)—NH—R⁵ (III),

wherein a is 0, y is 3, x is 2 to 4, R¹ is ethoxy, R³ is (CH₂)₃, R⁴ is phenyl, nitrophenyl or tert-butyl, R⁵ is a branched or unbranched alkyl radical, particularly preferably CH₂—CH(C₂H₅)—(CH₂)₃—CH₃.

The silane-azodicarbonamide mixture may contain further additives or consist solely of azocarbonyl-functionalized silane of formula I, silane of formula II and azodicarbonamide compound of formula III. Additives may be for example: solvents, for example methanol, ethanol, propanol, butanol, cyclohexanol, N,N-dimethylformamide, dimethyl sulfoxide, pentane, hexane, cyclohexane, heptane, octane, decane, toluene, xylene, acetone, acetonitrile, carbon tetrachloride, chloroform, dichloromethane, 1,2-dichloromethane, tetrachloroethylene, diethyl ether, methyl tert-butyl ether, methyl ethyl ketone, tetrahydrofuran, dioxane, pyridine or methyl acetate, amines of general formula IV

R⁸—NH₂ (IV),

wherein R⁸ represents a branched or unbranched, saturated or unsaturated, aliphatic or cyclic monovalent C1-C30-hydrocarbon group, preferably C1-C20-, particularly preferably C1-C10-, very particularly preferably C2-C8-, especially preferably CH(CH₃)₂, CH₂CH(CH₃)₂, C(CH₃)₃, CH₂C(CH₃)₃, CH₂CH₂CH(CH₃)₂, CH₂CH(CH₃) CH₂CH₃, CH₂CH(CH₂CH₃)₂, CH₂CH₂CH(CH₂CH₂CH₃)CH₂CH₂CH₂CH₃, CH₂CH(CH₂CH₃)CH₂CH₂CH₂CH₃, or a substituted or unsubstituted aryl group, preferably phenyl,
or silyl-functionalized amines of general formula V

(R⁹)₃₋ₐₐ(R¹⁰)ₐₐSi—R¹¹—NH₂ (V),
wherein R⁹ are identical or different and represent C1-C10-alkoxy groups or alkyl polyether group —O—(R⁶—O)ᵣR⁷ where R⁶ are identical or different and represent a branched or unbranched, saturated or unsaturated, aliphatic, aromatic or mixed aliphatic/aromatic divalent C1-C30-hydrocarbon group, r is an integer from 1 to 30 and R⁷ represents unsubstituted or substituted, branched or unbranched alkyl, alkenyl, aryl or aralkyl groups,
R¹⁰ are identical or different and represent —OH, C6-C20-aryl groups, preferably phenyl, C1-C10-alkyl groups, C2-C20-alkenyl group, C7-C20-aralkyl group or halogen,
aa may be 0 to 3,
R¹¹ represent a branched or unbranched, saturated or unsaturated, aliphatic, aromatic or mixed aliphatic/aromatic divalent C1-C30-hydrocarbon group, preferably C1-C20-, particularly preferably C1-C10-, very particularly preferably C2-C7-, especially preferably CH₂CH₂ and CH₂CH₂CH₂.

The silane-azodicarbonamide mixture according to the invention may comprise oligomers that form as a result of hydrolysis and condensation of the silanes of formula I and/or silanes of formula II.

The silane mixture according to the invention may be in a form applied to a carrier, for example wax, polymer or carbon black. The silane-azodicarbonamide mixture according to the invention may be in a form applied to a silica, wherein the bonding may be physical or chemical.

The present invention further provides a process for producing the silane-azodicarbonamide mixture according to the invention which is characterized in that it comprises mixing 5-95% by weight, preferably 5-50% by weight, particularly preferably 20-40% by weight, of azocarbonyl-functionalized silane of formula I based on the total amount of azocarbonyl-functionalized silane of formula I, silane of formula II and azodicarbonamide compound of formula III,

(R¹)₃₋ₐ(R²)ₐSi—R³—NH—C(O)—N═N—R⁴ (I),

0-90% by weight, preferably 20-60% by weight, particularly preferably 30-60% by weight, of silane of formula II based on the total amount of azocarbonyl-functionalized silane of formula I, silane of formula II and azodicarbonamide compound of formula III,

(R¹)_{y}(R²)_{3-y}Si—R³—Sₓ—R³—Si(R¹)_{y}(R²)_{3-y} (II) and

1-80% by weight, preferably 5-50% by weight, particularly preferably 15-40% by weight, of azodicarbonamide compound of formula III based on the total amount of azocarbonyl-functionalized silane of formula I, silane of formula II and azodicarbonamide compound of formula III,

R⁵—NH—C(O)—N═N—C(O)—NH—R⁵ (III),

The blending may be carried out after production of the individual components or else during production of the individual components at various suitable points. The blending of the azocarbonyl-functionalized silane of formula I and the silane of formula II may be carried out during production of the azodicarbonamide compound of formula III.

The process according to the invention may be performed with exclusion of air. The process according to the invention may be performed under a protective gas atmosphere, for example under argon or nitrogen, preferably under nitrogen.

The blending may preferably be carried out by mixing with a stirrer.

The process according to the invention may be performed at standard pressure, elevated pressure or reduced pressure. Preferably, the process according to the invention may be performed at standard pressure.

Elevated pressure may be a pressure of 1.1 bar to 100 bar, preferably of 1.1 bar to 50 bar, particularly preferably of 1.1 bar to 10 bar and very particularly preferably of 1.1 to 5 bar.

Reduced pressure may be a pressure of 1 mbar to 1000 mbar, preferably 250 mbar to 1000 mbar, more preferably 500 mbar to 1000 mbar.

The process according to the invention may be performed at between 0° C. and 100° C., preferably between 10° C. and 50° C., particularly preferably between 10° C. and 35° C.

The process according to the invention may be performed in a solvent, for example methanol, ethanol, propanol, butanol, cyclohexanol, N,N-dimethylformamide, dimethyl sulfoxide, pentane, hexane, cyclohexane, heptane, octane, decane, toluene, xylene, acetone, acetonitrile, carbon tetrachloride, chloroform, dichloromethane, 1,2-dichloroethane, tetrachloroethylene, diethyl ether, methyl tert-butyl ether, methyl ethyl ketone, tetrahydrofuran, dioxane, pyridine or methyl acetate, or a mixture of the aforementioned solvents. The process according to the invention may preferably be performed without solvent.

The volatile secondary components may be separated by distillation.

The distillative purification may be carried out either before or after mixing of the azocarbonyl-functionalized silane of formula I, the silane of formula II and the azodicarbonamide compound of formula III. The distillative purification may preferably be carried out after the blending of the azocarbonyl-functionalized silane of formula I, the silane of formula II and the azodicarbonamide compound of formula III.

The distillative purification may be performed in a batch process or via a thin-film evaporator.

The distillative purification may be performed with exclusion of air. The process may be performed under a protective gas atmosphere, for example under argon or nitrogen, preferably under nitrogen.

The distillative purification may be performed at standard pressure or reduced pressure. The process according to the invention may preferably be performed under reduced pressure.

Reduced pressure may be a pressure of 1 mbar to 1000 mbar, preferably 10 mbar to 200 mbar, particularly preferably 20 mbar to 1000 mbar.

The distillative purification may be performed at between 20° C. and 100° C., preferably between 20° C. and 80° C., particularly preferably between 30° C. and 60° C.

The invention further provides a rubber mixture comprising
at least one rubber,
5-95% by weight, preferably 5-50% by weight, particularly preferably 20-40% by weight, of azocarbonyl-functionalized silane of formula I based on the total amount of azocarbonyl-functionalized silane of formula I, silane of formula II and azodicarbonamide compound of formula III,

(R¹)₃₋ₐ(R²)ₐSi—R³—NH—C(O)—N═N—R⁴ (I),
0-90% by weight, preferably 20-60% by weight, particularly preferably 30-60% by weight, of silane of formula II based on the total amount of azocarbonyl-functionalized silane of formula I, silane of formula II and azodicarbonamide compound of formula III,

(R¹)_{y}(R²)_{3-y}Si—R³—Sₓ—R³—Si(R¹)_{y}(R²)_{3-y} (II) and
1-80% by weight, preferably 5-50% by weight, particularly preferably 15-40% by weight, of azodicarbonamide compound of formula III based on the total amount of azocarbonyl-functionalized silane of formula I, silane of formula II and azodicarbonamide compound of formula III,

R⁵—NH—C(O)—N═N—C(O)—NH—R⁵ (III),
wherein R¹ are identical or different and represent C1-C10-alkoxy groups, preferably methoxy or ethoxy groups, phenoxy group or alkylpolyether group —O—(R⁶—O)ᵣ—R⁷ where R⁶ are identical or different and represent a branched, saturated or unsaturated, aliphatic, aromatic or mixed aliphatic/aromatic divalent C1-C30 hydrocarbon group, preferably —CH₂—CH₂—, r is an integer from 1 to 30, preferably 3 to 10, and R⁷ represents unsubstituted or substituted, branched or unbranched monovalent alkyl, alkenyl, aryl or aralkyl groups, preferably represents C13H₂₇ alkyl group, R² are identical or different and represent —OH, C6-C20-aryl groups, preferably phenyl, C1-C10-alkyl groups, preferably methyl or ethyl, C2-C20-alkenyl group, C7-C20-aralkyl group or halogen, preferably Cl,
a is 0 to 3, preferably 0,
y is 0 to 3, preferably 3,
R³ are identical or different and represent a branched or unbranched, saturated or unsaturated, aliphatic, aromatic or mixed aliphatic/aromatic divalent C1-C30-hydrocarbon group, preferably C1-C20, particularly preferably C1-C10, very particularly preferably C2-C7-, especially preferably CH₂CH₂ and CH₂CH₂CH₂,
R⁴ represents a substituted or unsubstituted aryl or substituted or unsubstituted alkyl group, preferably phenyl, halophenyl, for example chlorophenyl, bromophenyl or iodophenyl, tolyl, alkoxyphenyl, for example methoxyphenyl, o-, m- or p-nitrophenyl, or substituted or unsubstituted alkyl, preferably methyl, ethyl, propyl, butyl, isobutyl, tert-butyl, nitromethyl, nitroethyl, nitropropyl, nitrobutyl or nitroisobutyl,
x is the average sulfur chain distribution, wherein x is 2 to 10, preferably 2 to 4,
R⁵ are identical or different and represent a branched or unbranched, saturated or unsaturated, aliphatic or cyclic monovalent C1-C30-hydrocarbon group, preferably C1-C20-, particularly preferably C1-C10-, very particularly preferably C2-C8-, especially preferably CH(CH₃)₂, CH₂CH(CH₃)₂, C(CH₃)₃, CH₂C(CH₃)₃, CH₂CH₂CH(CH₃)₂, CH₂CH(CH₃) CH₂CH₃, CH₂CH(CH₂CH₃)₂, CH₂CH₂CH(CH₂CH₂CH₃)CH₂CH₂CH₂CH₃, CH₂CH(CH₂CH₃)CH₂CH₂CH₂CH₃, or substituted or unsubstituted aryl group, preferably phenyl.

The rubber may preferably be a diene rubber, particularly preferably natural rubber, polyisoprene, polybutadiene, styrene-butadiene copolymers, isobutylene/isoprene copolymers, butadiene/acrylonitrile copolymers, ethylene/propylene/diene copolymers (EPDM), partly hydrogenated or fully hydrogenated NBR rubber.

Rubber used may be natural rubber and/or synthetic rubbers. Preferred synthetic rubbers are described for example in W. Hofmann, Kautschuktechnologie [Rubber Technology], Genter Verlag, Stuttgart 1980. They may include:
polybutadiene (BR),
polyisoprene (IR),
styrene/butadiene copolymers, for example emulsion SBR (E-SBR) or solution SBR (S—SBR), preferably having styrene contents of 1% to 60% by weight, more preferably 5% to 50% by weight (SBR),
chloroprene (CR)
isobutylene/isoprene copolymers (IIR),
butadiene/acrylonitrile copolymers having acrylonitrile contents of 5% to 60% by weight, preferably 10% to 50% by weight (NBR),
partially hydrogenated or fully hydrogenated NBR rubber (HNBR)
ethylene/propylene/diene copolymers (EPDM)
abovementioned rubbers which also have functional groups, e.g. carboxy, silanol or epoxy groups, for example epoxidized NR, carboxy-functionalized NBR or amine (NR₂), silanol (—SiOH)—, epoxy-, mercapto-, hydroxy-, or siloxy (—Si—OR)-functionalized SBR,
   and mixtures of these rubbers. The rubbers mentioned may additionally be silicon- or tin-coupled.

In a preferred embodiment, the rubbers may be sulfur-vulcanizable. For the production of car tyre treads it is in particular possible to use anionically polymerized S—SBR rubbers (solution SBR) with a glass transition temperature above −50° C., and also mixtures of these with diene rubbers. It is particularly preferably possible to use S—SBR rubbers whose butadiene portion has more than 20% by weight vinyl fraction. It is very particularly preferably possible to use S—SBR rubbers whose butadiene portion has more than 50% by weight vinyl fraction.

It is preferably possible to use mixtures of the abovementioned rubbers which have an S—SBR content of more than 50% by weight, preferably more than 60% by weight.

The rubber may be a functionalized rubber, where the functional groups may be amine and/or amide and/or urethane and/or urea and/or aminosiloxane and/or siloxane and/or silyl and/or alkylsilyl, for example N,N-bis(trimethylsilyl)aminopropylmethyldiethoxysilane or methyltriphenoxysilane, and/or halogenated silyl and/or silane sulfide and/or thiol and/or hydroxyl and/or ethoxy and/or epoxy and/or carboxyl and/or tin, for example tin tetrachloride or dibutyldichlorotin, and/or silanol and/or hexachlorodisiloxane and/or thiocarboxy and/or nitrile and/or nitroxide and/or amido and/or imino and/or urethane and/or urea and/or dimethylimidazolidinone and/or 2-methyl-2-thiazoline and/or 2-benzothiazoleacetonitrile and/or 2-thiophenecarbonitrile and/or 2-(N-methyl-N-3-trimethoxysilylpropyl)thiazoline and/or carbodiimide and/or N-substituted aminoaldehyde and/or N-substituted aminoketone and/or N-substituted aminothioaldehyde and/or N-substituted aminothioketone and/or benzophenone and/or thiobenzophenone with amino group and/or isocyanate and/or isothiocyanate and/or hydrazine and/or sulfonyl and/or sulfinyl and/or oxazoline and/or ester groups.

The rubber mixture according to the invention may contain at least one filler.

Fillers usable for the rubber mixtures according to the invention include the following fillers:
Carbon blacks: The carbon blacks may be produced by the lamp-black process, furnace-black process, gas-black process or thermal process and have BET surface areas of from 20 to 200 m²/g. The carbon blacks may optionally also contain heteroatoms, such as Si for example.
Amorphous silicas produced for example by precipitation from solutions of silicates or flame-hydrolysis of silicon halides with specific surface areas of from 5 to 1000 m²/g, preferably from 20 to 400 m²/g (BET surface area) and with primary particle sizes of from 10 to 400 nm. The silicas may optionally also be in the form of mixed oxides with other metal oxides, such as oxides of Al, Mg, Ca, Ba, Zn and titanium.
Synthetic silicates such as aluminium silicate, alkaline earth metal silicates such as magnesium silicate or calcium silicate, with BET surface areas of from 20 to 400 m²/g and primary particle diameters of from 10 to 400 nm.
Synthetic or natural aluminium oxides and synthetic or natural aluminium hydroxides.
Natural silicates, such as kaolin and other naturally occurring silicas.
Glass fibres and glass-fibre products (mats, strands) or glass microbeads.

It is possible with preference to use amorphous silicas prepared by precipitation from solutions of silicates, with BET surface areas of 20 to 400 m²/g, more preferably 100 m²/g to 250 m²/g, in amounts of 5 to 150 parts by weight, based in each case on 100 parts of rubber.

With very particular preference, it is possible to use precipitated silicas as filler.

The fillers mentioned may be used alone or in a mixture.

The rubber mixtures according to the invention may contain 5 to 150 parts by weight of filler and 0.1 to 30 parts by weight, preferably 2 to 25 parts by weight, particularly preferably 5 to 20 parts by weight, of the silane-azodicarbonamide mixture according to the invention, wherein the parts by weight are based on 100 parts by weight of rubber.

The silane-azodicarbonamide mixture according to the invention may be used as adhesion promoters between inorganic materials, for example glass beads, glass shards, glass surfaces, glass fibres, or oxidic fillers, preferably silicas such as precipitated silicas and formed silicas, and organic polymers, for example thermosets, thermoplastics or elastomers, or as crosslinking agents and surface modifiers for oxidic surfaces.

The silane-azodicarbonamide mixture according to the invention can be used as coupling reagents in filled rubber mixtures, examples being tyre treads, industrial rubber articles or footwear soles.

The rubber mixtures according to the invention may comprise further rubber auxiliaries, such as reaction accelerators, ageing stabilizers, heat stabilizers, light stabilizers, antiozonants, processing aids, plasticizers, resins, tackifiers, blowing agents, dyes, pigments, waxes, extenders, organic acids, retarders, metal oxides, and activators such as diphenylguanidine, triethanolamine, polyethylene glycol, alkoxy-terminated polyethylene glycol alkyl-O—(CH₂—CH₂—O)_{y}i-H with y¹=2-25, preferably y¹=2-15, more preferably y¹=3-10, most preferably y¹=3-6, or hexanetriol, that are familiar to the rubber industry.

The rubber auxiliaries may be used in familiar amounts determined inter alia by factors including the intended use. Customary amounts may, for example, be amounts of 0.1% to 50% by weight based on rubber. Crosslinkers used may be peroxides, sulfur or sulfur donor substances. The rubber mixtures according to the invention may further comprise vulcanization accelerators. Examples of suitable vulcanization accelerators may be mercaptobenzothiazoles, sulfenamides, thiurams, dithiocarbamates, thioureas and thiocarbonates. The vulcanization accelerators and sulfur may be used in amounts of 0.1% to 10% by weight, preferably 0.1% to 5% by weight, based on 100 parts by weight of rubber.

The rubber mixtures according to the invention can be vulcanized at temperatures of 100° C. to 200° C., preferably 120° C. to 180° C., optionally at a pressure of 10 to 200 bar. The blending of the rubbers with the filler, optionally rubber auxiliaries and the silane-azodicarbonamide mixtures may be carried out in known mixing units, such as rollers, internal mixers and mixing extruders.

The rubber mixtures according to the invention can be used for production of moulded articles, for example for the production of tyres, especially pneumatic tyres or tyre treads, cable sheaths, hoses, drive belts, conveyor belts, roller coverings, footwear soles, sealing rings and damping elements.

Advantages of the silane-azodicarbonamide mixtures according to the invention are improved stress values and a more balanced result in rebound resilience measurements in rubber mixtures.

### EXAMPLES

### Substances Used

### Example 1

Si 69™ (bis-[3-(triethoxysilyl)-propyl]-tetrasulfide) from Evonik Operations GmbH is employed as example 1.

### Example 2

2-Phenyl-N-(3-(triethoxysilyl)propyl)diazenecarboxamide produced according to EP 2 937 351, example 7, is employed as example 2.

### Example 3

### Production of N,N-bis(2-ethylhexyl)azodicarbonamide

2-Ethylhexylamine and pentane were cooled to 0° C. in a 2 L flask with stirrer and reflux condenser. Diisopropyl diazodicarboxylate (DIAD) was slowly added while the temperature was maintained at 0° C. The mixture was stirred for a further 30 min at this temperature and then stirred for two to three hours at 20° C. The crude product N,N-bis(2-ethylhexyl)azodicarbonamide was obtained as a solution in pentane and isopropanol. The reaction conversion was monitored by HPLC analysis. The solvent was removed in vacuo and the product obtained as a deep-red solid in >=70% purity (determined by ¹H-NMR analysis).

### Example 4: Production of blend of Si 69™ and 2-phenyl-N-(3-(triethoxysilyl)propyl)diazenecarboxamide and N,N-bis(2-ethylhexyl)azodicarbonamide

2-Ethylhexylamine (291 g, 2.25 mol) and pentane (122 g, 1.69 mol) were cooled to 5° C. in a 2 L flask with stirrer and reflux condenser. Diisopropyl diazodicarboxylate (DIAD) (227 g, 1.16 mol) was slowly added while the temperature was maintained at 5° C. The mixture was stirred for a further 30 min at 0° C. and then stirred for two to three hours at 20° C. The resulting solution of N,N-bis(2-ethylhexyl)azodicarbonamide was subsequently divided and a quarter of this solution (126.0 g, 60% in iPrOH/pentane, 0.28 mol) admixed with Si 69™ (95 g, 0.18 mol) und 2-phenyl-N-(3-(triethoxysilyl)propyl)diazenecarboxamide (128 g, 0.36 mol). The reaction solution was stirred at 20° C. for 5 min. Pentane was distilled off at 40° C. and 500 mbar, before a vacuum of 20 mbar was applied at 40-60° C. with stirring and pentane and iPrOH were removed by distillation. The distilled mixed product was analyzed by NMR and GC.

Si 69: 30% (¹H-NMR, DMSO-d6)

2-Phenyl-N-(3-(triethoxysilyl)propyl)diazenecarboxamide: 40% (1H-NMR, DMSO-d6)

N,N-bis(2-ethylhexyl)azodicarbonamide: 30% (¹H-NMR, DMSO-d6)

Isopropanol: 0.3% (GC)

### Example 5: Natural Rubber Mixture (NR)

The materials used are listed in table 1.

TABLE 1
List of materials used in Example 5

| | |
|---|---|
| ULTRASIL ® 7000 GR | Silica, Evonik Operations GmbH |
| ZnO | Rotsiegel zinc oxide, Grillo Zinkoxid GmbH |
| Stearic acid | Edenor ST1, Caldic Deutschland GmbH |
| Wax | Protektor G 3108, Paramelt B.V. |
| 6-PPD | Vulkanox ® 4020/LG, Rhein-Chemie GmbH |
| TMQ | Vulkanox ® HS/LG, Rhein-Chemie GmbH |
| CBS | Vulkacit ® CZ/EG-C, Rhein-Chemie GmbH |
| Sulfur | Ground sulfur, Azelis S.A. |
| TBzTD | Richon TBzTD OP, Weber & Schaer |
| | GmbH & Co. KG |
| SMR 10 (decomposed) | SMR 10, Wurfbain Nordmann GmbH |
| | masticated to 60-70 Mooney units (M_{L(1+4)}) |
| | by Harburg-Freudenberger Maschinenbau |
| | GmbH |

The formulation used for the rubber mixtures is specified in table 2. The unit phr means parts by weight based on 100 parts of the raw rubber used.

TABLE 2
Mixture formulation of an NR mixture

| | | Compar- | Compar- | Compar- | Inven- | Inven- | Inven- | Inven- | Inven- |
|---|---|---|---|---|---|---|---|---|---|
| | | ative | ative | ative | tive | tive | tive | tive | tive |
| | | mixture 1 | mixture 2 | mixture 3 | mixture 1 | mixture 2 | mixture 3 | mixture 4 | mixture 5 |
| 1st mixing | | | | | | | | | |
| stage | | | | | | | | | |
| SMR 10 | phr | 100.00 | 100.00 | 100.00 | 100.00 | 100.00 | 100.00 | 100.00 | 100.00 |
| (decomposed) | | | | | | | | | |
| ULTRASIL | phr | 55.00 | 55.00 | 55.00 | 55.00 | 55.00 | 55.00 | 55.00 | 55.00 |
| 7000 GR | | | | | | | | | |
| Example 1 | phr | 8.86 | 8.86 | 8.86 | 0.00 | 0.00 | 0.00 | 4.43 | 6.65 |
| Example 2 | phr | 0.00 | 0.00 | 0.00 | 11.80 | 11.80 | 11.80 | 5.89 | 2.95 |
| Example 3 | phr | 0.00 | 3.75 | 1.5 | 1.50 | 3.75 | 6.00 | 4.43 | 2.63 |
| Example 4 | phr | 0.00 | 0.00 | 0.00 | 0.00 | 0.00 | 0.00 | 0.00 | 0.00 |
| Stearic acid | phr | 3.00 | 3.00 | 3.00 | 3.00 | 3.00 | 3.00 | 3.00 | 3.00 |
| ZnO | phr | 3.00 | 3.00 | 3.00 | 3.00 | 3.00 | 3.00 | 3.00 | 3.00 |
| 6-PPD | phr | 1.00 | 1.00 | 1.00 | 1.00 | 1.00 | 1.00 | 1.00 | 1.00 |
| TMQ | phr | 1.00 | 1.00 | 1.00 | 1.00 | 1.00 | 1.00 | 1.00 | 1.00 |
| Wax | phr | 1.00 | 1.00 | 1.00 | 1.00 | 1.00 | 1.00 | 1.00 | 1.00 |
| 2nd mixing | | | | | | | | | |
| stage | | | | | | | | | |
| Mixture from | phr | 172.86 | 176.61 | 174.36 | 177.30 | 179.55 | 181.80 | 178.08 | 176.22 |
| 1st mixing | | | | | | | | | |
| stage | | | | | | | | | |
| 3rd mixing | | | | | | | | | |
| stage | | | | | | | | | |
| Mixture from | phr | 172.86 | 176.61 | 174.36 | 177.30 | 179.55 | 181.80 | 178.08 | 176.22 |
| 2nd mixing | | | | | | | | | |
| stage | | | | | | | | | |
| CBS | phr | 0.80 | 0.80 | 0.80 | 0.80 | 0.80 | 0.80 | 0.80 | 0.80 |
| Sulfur | phr | 1.03 | 1.03 | 1.03 | 1.97 | 1.97 | 1.97 | 1.50 | 1.27 |
| TBzTD | phr | 0.20 | 0.20 | 0.20 | 0.20 | 0.20 | 0.20 | 0.20 | 0.20 |

| | | Inven- | Inven- | Inven- | Inven- | Inven- | Inven- |
|---|---|---|---|---|---|---|---|
| | | tive | tive | tive | tive | tive | tive |
| | | mixture 6 | mixture 7 | mixture 8 | mixture 9 | mixture 10 | mixture 11 |
| 1st mixing | | | | | | | |
| stage | | | | | | | |
| SMR 10 | phr | 100.00 | 100.00 | 100.00 | 100.00 | 100.00 | 100.00 |
| (decomposed) | | | | | | | |
| ULTRASIL | phr | 55.00 | 55.00 | 55.00 | 55.00 | 55.00 | 55.00 |
| 7000 GR | | | | | | | |
| Example 1 | phr | 6.65 | 4.43 | 4.43 | 2.22 | 2.22 | 0 |
| Example 2 | phr | 2.95 | 5.90 | 5.90 | 8.85 | 8.85 | 0 |
| Example 3 | phr | 4.88 | 6.00 | 1.50 | 4.88 | 2.63 | 0 |
| Example 4 | phr | 0.00 | 0.00 | 0.00 | 0.00 | 0.00 | 14.75 |
| Stearic acid | phr | 3.00 | 3.00 | 3.00 | 3.00 | 3.00 | 3.00 |
| ZnO | phr | 3.00 | 3.00 | 3.00 | 3.00 | 3.00 | 3.00 |
| 6-PPD | phr | 1.00 | 1.00 | 1.00 | 1.00 | 1.00 | 1.00 |
| TMQ | phr | 1.00 | 1.00 | 1.00 | 1.00 | 1.00 | 1.00 |
| Wax | phr | 1.00 | 1.00 | 1.00 | 1.00 | 1.00 | 1.00 |
| 2nd mixing | | | | | | | |
| stage | | | | | | | |
| Mixture from | phr | 178.47 | 180.33 | 175.83 | 179.94 | 177.69 | 177.69 |
| 1st mixing | | | | | | | |
| stage | | | | | | | |
| 3rd mixing | | | | | | | |
| stage | | | | | | | |
| Mixture from | phr | 178.47 | 180.33 | 175.83 | 179.94 | 177.69 | 177.69 |
| 2nd mixing | | | | | | | |
| stage | | | | | | | |
| CBS | phr | 0.80 | 0.80 | 0.80 | 0.80 | 0.80 | 0.80 |
| Sulfur | phr | 1.27 | 1.50 | 1.50 | 1.73 | 1.73 | 1.53 |
| TBzTD | phr | 0.20 | 0.20 | 0.20 | 0.20 | 0.20 | 0.20 |

Mixture production is described in table 3.

The elastomer mixtures were produced with a GK 1.5 E internal mixer from Harburg Freudenberger Maschinenbau GmbH. Test methods used for the mixtures and vulcanizates thereof were effected according to table 4.

TABLE 3
Mixture production of an NR mixture

| | |
|---|---|
| 1st stage | GK 1.5 E, kneader fill factor 0.65; 65 rpm; kneader temperature: 65° C. |
| min:sec | Desired mixing temperature: 140-150° C. |
| 00:00-00:30 | Add polymer; close ram and mix for 30 s |
| 00:30-01:30 | Add ½ of silica, silane/silanes; close ram and mix for 60 s |
| 01:30-01:30 | Lift ram to vent, clean ram |
| 01:30-02:30 | Add ½ of silica, remaining constituents from the first stage; close ram |
| | and mix for 60 s |
| 02:30-02:30 | Lift ram to vent, clean ram |
| 02:30-04:00 | Close ram and mix for 90 s; maintain temperature at 140° C.-150° C. |
| | optionally by varying mixer speed |
| 04:00-04:00 | Lift ram to vent |
| 04:00-05:00 | Close ram and mix for 60 s; maintain temperature at 140° C.-150° C. |
| | optionally by varying mixer speed |
| 5:00 | Discharge mixture and check weight |
| | Form a milled sheet on a laboratory roller mill (2 roller calendars) for 45 s |
| | at a roller gap of 4 mm and finally discharge said sheet |
| Storage: 24 h/RT | |
| 2nd stage | GK 1.5 E, kneader fill factor 0.62; 80 rpm; kneader temperature: 80° C. |
| | Desired mixing temperature: 140-150° C. |
| 00:00-01:00 | Add mixture from 1st stage; close ram and mix for 60 s |
| 01:00-03:00 | Mix for further 120 s, maintain temperature at 140° C.-150° C. optionally by |
| | varying mixer speed |
| 3:00 | Discharge mixture and check weight |
| | Form a milled sheet on a laboratory roller mill (2 roller calendars) for 45 s |
| | at a roller gap of 4 mm and finally discharge said sheet |
| Storage: 4-24 h/RT | |
| 3rd stage | GK 1.5 E, kneader fill factor 0.59; 55 rpm; kneader temperature: 50° C. |
| | Desired mixing temperature: 90-110° C. |
| 00:00-02:00 | Add mixture from 2nd stage; accelerator, sulfur; close ram and mix for 120 s |
| 02:00 | Discharge mixture and form a milled sheet on a laboratory roller mill (2 |
| | roller calendars) for 20 s at a roller gap of 3-4 mm |
| Storage: 12 h/RT | |

TABLE 4
List of physical tests used

| Method | Standard |
|---|---|
| Test at 23° C.: Standard bar S1; Takeoff speed: 500 mm/ | DIN 53 504 |
| min for determining 300% stress value/MPa | |
| Rebound resilience; 60° C./% | ASTM D 2632 |
| Rebound resilience; 60° C.-23° C./% | ASTM D 2632 |

TABLE 5
Results of physical tests on vulcanizates

| | | | | | Inven- | Inven- | Inven- | Inven- |
|---|---|---|---|---|---|---|---|---|
| | | Compar- | Compar- | Compar- | tive | tive | tive | tive |
| | | ative | ative | ative | mixture | mixture | mixture | mixture |
| | Unit | mixture 1 | mixture 2 | mixture 3 | 1 | 2 | 3 | 4 |
| 300% | MPa | 13.1 | 12 | 13.7 | 21.4 | 19.8 | 17.7 | 16.0 |
| stress | | | | | | | | |
| value | | | | | | | | |
| Rebound | % | 73.4 | 70.2 | 71.6 | 71.6 | 67.8 | 65.7 | 70.1 |
| resilience; | | | | | | | | |
| 60° C. | | | | | | | | |
| Rebound | % | 11.6 | 12.2 | 12.2 | 12.2 | 11.9 | 12.0 | 13.8 |
| resilience; | | | | | | | | |
| 60° C.- | | | | | | | | |
| 23° C. | | | | | | | | |

| | | Inven- | Inven- | Inven- | Inven- | Inven- | Inven- | Inven- |
|---|---|---|---|---|---|---|---|---|
| | | tive | tive | tive | tive | tive | tive | tive |
| | | mixture | mixture | mixture | mixture | mixture | mixture | mixture |
| | Unit | 5 | 6 | 7 | 8 | 9 | 10 | 11 |
| 300% | MPa | 15.3 | 14.3 | 14.4 | 17.3 | 18.6 | 19.4 | 15.6 |
| stress | | | | | | | | |
| value | | | | | | | | |
| Rebound | % | 72.5 | 70.7 | 70.4 | 74.9 | 71.4 | 70.6 | 69.5 |
| resilience; | | | | | | | | |
| 60° C. | | | | | | | | |
| Rebound | % | 13.0 | 13.1 | 14.2 | 13.4 | 12.9 | 13.1 | 14.0 |
| resilience; | | | | | | | | |
| 60° C.- | | | | | | | | |
| 23° C. | | | | | | | | |

It is apparent from table 5 that the vulcanizates of the inventive mixtures 1-11 comprising the inventive silane-azodicarbonamide mixtures exhibit a markedly improved 300% stress value compared to the comparative mixtures 1-3.

Inventive mixtures 4 and 11 are identical to examples 1-3 in terms of composition. Inventive mixture 4 was produced during mixing by addition of the individual components examples 1-3 to the internal mixer, while in the case of inventive mixture 11 a premixture of examples 1-3 is added. Similar results are obtained irrespective of whether the silane-azodicarbonamide mixture is produced as a premixture or produced during mixing.

### Example 6: Natural Rubber Mixture (NR)

The materials used are listed in table 1.

The formulation used for the rubber mixtures is specified in table 6. The unit phr means parts by weight based on 100 parts of the raw rubber used.

TABLE 6
Mixture formulation of an NR mixture

| | | Comparative | Inventive | Inventive |
|---|---|---|---|---|
| | | mixture 4 | mixture 12 | mixture 13 |
| 1st mixing | | | | |
| stage | | | | |
| SMR 10 | phr | 100.00 | 100.00 | 100.00 |
| (decomposed) | | | | |
| ULTRASIL | phr | 55.00 | 55.00 | 55.00 |
| 7000 GR | | | | |
| Example 1 | phr | 2.75 | 2.75 | 2.75 |
| Example 2 | phr | 3.70 | 3.70 | 3.70 |
| Example 3 | phr | 0.00 | 3.00 | 6.00 |
| Stearic acid | phr | 3.00 | 3.00 | 3.00 |
| ZnO | phr | 3.00 | 3.00 | 3.00 |
| 6-PPD | phr | 1.00 | 1.00 | 1.00 |
| TMQ | phr | 1.00 | 1.00 | 1.00 |
| Wax | phr | 1.00 | 1.00 | 1.00 |
| 2nd mixing | | | | |
| stage | | | | |
| Mixture from | phr | 170.45 | 173.45 | 176.45 |
| 1st mixing | | | | |
| stage | | | | |
| 3rd mixing | | | | |
| stage | | | | |
| Mixture from | phr | 170.45 | 173.45 | 176.45 |
| 2nd mixing | | | | |
| stage | | | | |
| CBS | phr | 1.00 | 1.00 | 1.00 |
| Sulfur | phr | 1.40 | 1.40 | 1.40 |

Mixture production is described in table 3.

The elastomer mixtures were produced with a GK 1.5 E internal mixer from Harburg Freudenberger Maschinenbau GmbH. Test methods used for the mixtures and vulcanizates thereof were effected according to table 7. The vulcanizates were produced in a vulcanizing press at 150° C. with a hot time of 30 min.

TABLE 7
List of physical tests used

| Method | Standard |
|---|---|
| Test at 23° C.: Standard bar S1; Takeoff speed: 500 mm/ | DIN 53 504 |
| min for determining 300% stress value/MPa | |
| M_{L} (1 + 4) at 100° C. | DIN 53523-3 |

TABLE 8
Results of the physical tests

| | | Comparative | Inventive | Inventive |
|---|---|---|---|---|
| | Unit | mixture 4 | mixture 12 | mixture 13 |
| 300% stress value | MPa | 10.2 | 11.7 | 10.7 |
| M_{L}(1 + 4) at 100° C. | | 52 | 42 | 37 |
| 3rd mixing stage | | | | |

It is apparent from table 8 that the vulcanizates of the inventive mixtures 12 and 13 comprising the inventive silane-azodicarbonamide mixture exhibit a markedly improved 300% stress value compared to the comparative mixture 4. The Mooney viscosity is additionally significantly lower.

1. Silane-azodicarbonamide mixture containing 5-95% by weight of azocarbonyl-functionalized silane of formula I based on the total amount of azocarbonyl-functionalized silane of formula I, silane of formula II and azodicarbonamide of formula III,
(R¹)₃₋ₐ(R²)ₐSi—R³—NH—C(O)—N═N—R⁴ (I),
0-90% by weight of silane of formula II based on the total amount of azocarbonyl-functionalized silane of formula I, silane of formula II and azodicarbonamide compound of formula III,
(R¹)_{y}(R²)_{3-y}Si—R³—Sₓ—R³—Si(R¹)_{y}(R²)_{3-y} (II) and
1-80% by weight of azodicarbonamide compound of formula III based on the total amount of azocarbonyl-functionalized silane of formula I, silane of formula II and azodicarbonamide compound of formula III,
R⁵—NH—C(O)—N═N—C(O)—NH—R⁵ (III),
wherein R¹ are identical or different and represent C1-C10-alkoxy groups, phenoxy group or alkylpolyether group —O—(R⁶—O)ᵣ—R⁷ where R⁶ are identical or different and represent a branched, saturated or unsaturated, aliphatic, aromatic or mixed aliphatic/aromatic divalent C1-C30 hydrocarbon group, r is an integer from 1 to 30 and R⁷ represents unsubstituted or substituted, branched or unbranched monovalent alkyl, alkenyl, aryl or aralkyl groups, R² are identical or different and represent —OH, C6-C20-aryl groups, C1-C10-alkyl groups, C2-C20-alkenyl group, C7-C20-aralkyl group or halogen,
a is 0 to 3,
y is 0 to 3,
R³ are identical or different and represent a branched or unbranched, saturated or unsaturated, aliphatic, aromatic or mixed aliphatic/aromatic divalent C1-C30-hydrocarbon group,
R⁴ represents a substituted or unsubstituted aryl or substituted or unsubstituted alkyl group,
x is the average sulfur chain distribution, wherein x is 2 to 10,
R⁵ are identical or different and represent a branched or unbranched, saturated or unsaturated, aliphatic or cyclic monovalent C1-C30-hydrocarbon group or a substituted or unsubstituted aryl group.

2. Silane-azodicarbonamide mixture according to claim 1, characterized in that the azocarbonyl-functionalized silane of formula I is (CH₃CH₂O—)₃Si—(CH₂)₃—NH—CO—N═N-phenyl, (CH₃O—)₃Si—(CH₂)₃—NH—CO—N═N-phenyl or (CH₃CH₂O—)₃Si—(CH₂)₃—NH—CO—N═N-(p-nitrophenyl).

3. Silane-azodicarbonamide mixture according to claim 1, characterized in that the silane of formula II is [(EtO)₃Si(CH₂)₃]₂S, [(EtO)₃Si(CH₂)₃]₂S₂, [(EtO)₃Si(CH₂)₃]₂S₃ or [(EtO)₃Si(CH₂)₃]₂S₄.

4. Silane-azodicarbonamide mixture according to claim 1, characterized in that the azodicarbonamide compound of formula III is CH₃(CH₂)₅—NH—C(═O)—N═N—C(═O)—NH—(CH₂)₅—CH₃, CH₃(CH₂)₇—NH—C(═O)—N═N—C(═O)—NH—(CH₂)₇—CH₃, CH₃(CH₂)₃—CH(C₂H₅)—CH₂—NH—C(═O)—N═N—C(═O)—NH—CH₂—CH(C₂H₅)—(CH₂)₃—CH₃ or CH₃—(CH₂)₃—CH(C₃H₇)—CH₂—CH₂—NH—C(═O)—N═N—C(═O)—NH—CH₂—CH₂—CH(C₃H₇)—(CH₂)₃—CH₃.

5. Silane-azodicarbonamide mixture according to claim 1, characterized in that a is 0, y is 3, x is 2 to 4, R¹ is ethoxy, R³ is (CH₂)₃, R⁴ is phenyl, nitrophenyl or tert-butyl, R⁵ is a branched or unbranched alkyl radical.

6. Process for producing the silane-azodicarbonamide mixture according to claim 1, characterized in that it comprises mixing 5-95% by weight of azocarbonyl-functionalized silane of formula I based on the total amount of azocarbonyl-functionalized silane of formula I, silane of formula II and azodicarbonamide compound of formula III,
(R¹)₃₋ₐ(R²)ₐSi—R³—NH—C(O)—N═N—R⁴ (I),
0-90% by weight of silane of formula II based on the total amount of azocarbonyl-functionalized silane of formula I, silane of formula II and azodicarbonamide compound of formula III,
(R¹)_{y}(R²)_{3-y}Si—R³—Sₓ—R³—Si(R¹)_{y}(R²)_{3-y} (II) and
1-80% by weight of azodicarbonamide compound of formula III based on the total amount of azocarbonyl-functionalized silane of formula I, silane of formula II and azodicarbonamide compound of formula III,
R⁵—NH—C(O)—N═N—C(O)—NH—R⁵ (III).

7. Process for producing the silane-azodicarbonamide mixture according to claim 6, characterized in that the azocarbonyl-functionalized silane of formula I and the silane of formula II are added during production of the azodicarbonamide compound of formula III.

8. Rubber mixture containing at least one rubber, 5-95% by weight of azocarbonyl-functionalized silane of formula I based on the total amount of azocarbonyl-functionalized silane of formula I, silane of formula II and azodicarbonamide compound of formula III,
(R¹)₃₋ₐ(R²)ₐSi—R³—NH—C(O)—N═N—R⁴ (I),
0-90% by weight of silane of formula II based on the total amount of azocarbonyl-functionalized silane of formula I, silane of formula II and azodicarbonamide compound of formula III,
(R¹)_{y}(R²)_{3-y}Si—R³—Sₓ—R³—Si(R¹)_{y}(R²)_{3-y} (II) and
1-80% by weight of azodicarbonamide compound of formula III based on the total amount of azocarbonyl-functionalized silane of formula I, silane of formula II and azodicarbonamide compound of formula III,
R⁵—NH—C(O)—N═N—C(O)—NH—R⁵ (III),
wherein R¹ are identical or different and represent C1-C10-alkoxy groups, phenoxy group or alkylpolyether group —O—(R⁶—O)ᵣ—R⁷ where R⁶ are identical or different and represent a branched, saturated or unsaturated, aliphatic, aromatic or mixed aliphatic/aromatic divalent C1-C30 hydrocarbon group, r is an integer from 1 to 30 and R⁷ represents unsubstituted or substituted, branched or unbranched monovalent alkyl, alkenyl, aryl or aralkyl groups, R² are identical or different and represent —OH, C6-C20-aryl groups, C1-C10-alkyl groups, C2-C20-alkenyl group, C7-C20-aralkyl group or halogen,
a is 0 to 3,
y is 0 to 3,
R³ are identical or different and represent a branched or unbranched, saturated or unsaturated, aliphatic, aromatic or mixed aliphatic/aromatic divalent C1-C30-hydrocarbon group,
R⁴ represents a substituted or unsubstituted aryl or substituted or unsubstituted alkyl group,
x is the average sulfur chain distribution, wherein x is 2 to 10,
R⁵ are identical or different and represent a branched or unbranched, saturated or unsaturated, aliphatic or cyclic monovalent C1-C30-hydrocarbon group or a substituted or unsubstituted aryl group.

9. Rubber mixture according to claim 8, characterized in that the azocarbonyl-functionalized silane of formula I is (CH₃CH₂O—)₃Si—(CH₂)₃—NH—CO—N═N-phenyl, (CH₃O—)₃Si—(CH₂)₃—NH—CO—N═N-phenyl or (CH₃CH₂O—)₃Si—(CH₂)₃—NH—CO—N═N-(p-nitrophenyl).

10. Rubber according to claim 8, characterized in that the silane of formula II is [(EtO)₃Si(CH₂)₃]₂S, [(EtO)₃Si(CH₂)₃]₂S₂, [(EtO)₃Si(CH₂)₃]₂S₃ or [(EtO)₃Si(CH₂)₃]₂S₄.

11. Rubber mixture according to claim 8, characterized in that the azodicarbonamide compound of formula III is CH₃(CH₂)₅—NH—C(═O)—N═N—C(═O)—NH—(CH₂)₅—CH₃, CH₃(CH₂)₇—NH—C(═O)—N═N—C(═O)—NH—(CH₂)₇—CH₃, CH₃(CH₂)₃—CH(C₂H₅)—CH₂—NH—C(═O)—N═N—C(═O)—NH—CH₂—CH(C₂H₅)—(CH₂)₃—CH₃ or CH₃—(CH₂)₃—CH(C₃H₇)—CH₂—CH₂—NH—C(═O)—N═N—C(═O)—NH—CH₂—CH₂—CH(C₃H₇)—(CH₂)₃—CH₃.

12. Rubber mixture according to claim 8, characterized in that a is 0, y is 3, x is 2 to 4, R¹ is ethoxy, R³ is (CH₂)₃, R⁴ is phenyl, nitrophenyl or tert-butyl, R⁵ is a branched or unbranched alkyl radical.

13. Use of rubber mixtures according to claim 8 for production of tyres, cable sheaths, hoses, drive belts, conveyor belts, roller coverings, footwear soles, sealing rings and damping elements.
